(19) United States
(12) Patent Application Publication
(10) Pub. No.: US 2009/0201122 A1
(43) Pub. Date: Aug. 13, 2009

(54) Method for generating an information signal in the event of an access request and device for carrying out the method

(76) Inventor: Anatoli Stobbe, Barsinghausen (DE)

Correspondence Address: COLLARD & ROE, P.C., 1077 NORTHERN BOULEVARD, ROSLYN, NY, 11576, US

(21) Appl. No.: 12/322,802

(22) Filed: Feb. 6, 2009

(30) Foreign Application Priority Data
Feb. 9, 2008 (DE) 10 2008 008 366.6

(51) Int. Cl. G05B 23/02

(52) U.S. Cl. 340/3.1

(57) ABSTRACT

A method for generating an information signal in the event of an access request and a device for carrying out the method are described.

A feedback signal is output as an information signal to a user after entering or automatic reading of an identification code and comparing the identification code with stored reference data.

The type and intensity of the feedback signal is controlled as a function of parameters from the plurality of ambient parameters and person-related parameters.

The invention relates to a method for generating an information signal in the event of an access request according to the preamble of claim 1 and a device for carrying out the method according to the preamble of claim 13.

Access control devices are used by authorities and commercial businesses to secure protected site areas or building areas against the free access of unauthorised persons and to only grant access to authorised persons. In order to grant an authorised person access to the protected area, an identification code input by the person is evaluated or an identification code carried on a data carrier is read and if the result of the examination is positive, access is granted by releasing the lock on a door or automatically opening the door.

The access control device usually has signal generators which, after evaluating the access request, feed back the evaluation result, possibly in the form that access is allowed, access is denied or that a fault exists, possibly a read error during reading of an identification data carrier.

Problems with the detection of the feedback signal can arise if a visual feedback signal is not detected on account of too-high ambient brightness or an audible feedback signal is not perceived on account of too-high ambient noise. In addition, due to a disability such as, for example, visual impairment or hearing impairment or both disabilities at the same time, persons may not be capable of perceiving the hitherto usual feedback signals or even finding the user communication terminal of the access control device.

It is the object of the invention to provide a method for generating an information signal in the event of an access request s well as a device for carrying out the method which allows perception by a user even when adversely affected by the surroundings or person-related properties.

This object is achieved in a method according to the preamble of claim 1 by the features of this claim and in a device for carrying out the method according to the preamble of claim 13 by the features of that claim.

Further developments and advantageous embodiments are obtained from the dependent claims.

The basic idea of the invention consists in adapting information signals individually to the requirements so that on the one hand, perception by the person requesting access is ensured as intended but on the other hand, the use of energy for transmitting the information signal is kept as low as possible. The reason for the latter is firstly to be found in the sparing use of energy but secondly in the technical aspect since the electrical power transmitted via data cables to the access control device is usually limited. Since the type and intensity of the information signal is controlled as a function of ambient parameters and person-related parameters, the power and energy requirement of the access control device is limited to that precisely required. Furthermore, a general disturbance of persons located in the vicinity of the user communication terminal of the access control device by the information signals is avoided.

Information signals in the sense of the invention are feedback signals which are generated after evaluating an access request as well as orientation signals generated before evaluating an access request in order to make it easier or even possible for a user to locate an input device of the user communication terminal for transmitting his access request.

According to a further development, feedback signals are selected from the plurality of visual feedback signal, audible feedback signal, tactile feedback signal individually or in combination, as a function of ambient parameters and person-related parameters and are adjusted in intensity with respect to perturbing parameters with a signal-to-noise ratio with respect to the ambient parameters, which allows reliable perception.

In addition to a specified selection of feedback signals for the particular person concerned, who wishes to make an access request, the perception of the feedback signal is ensured, whereby at the same time only the power required for the individual feedback case is used and thus any perturbing influence on persons located in the vicinity of the user communication terminal of the access control device is avoided.

The type of feedback signals and the intensity of the intensity-controllable feedback signals can be fixedly adjusted.

By this means, the type and intensity of the feedback signals can be adjusted to the usual or predicted requirement for the installation site of the respective user communication terminal of the access control device, but can also be adapted manually in the event of variations.

Alternatively, the type of feedback signals and the intensity of the intensity-controllable feedback signals can be automatically adjusted and adapted to the ambient parameters.

In this embodiment, the type and intensity of the feedback signals are adapted independently without manual intervention.

Furthermore, the intensity-controllable feedback signals can be pre-adjusted to a base value and the intensity then only raised when the signal-to-noise ratio resulting from the ambient parameters falls below a predetermined limiting value.

By this means, the energy and power requirement is restricted to the minimum for as often and as long as possible and is only increased when necessary.

The intensity of the feedback signals can be controlled by sensors which detect the ambient parameters.

In this way, it is possible to raise the feedback signals not generally when there is a variation in the ambient parameters, but individually related to the type of variation.

According to a further development, the type of feedback signals can be controlled by sensors which detect the ambient parameters.

Under conditions of extreme brightness and extreme noise under which neither a visual nor an audible feedback could be detected even at maximum signal intensity, it is therefore possible to select a tactile feedback signal e.g. a vibration signal and generate this at the user communication terminal. In addition, the visual and audible feedback signal can be switched off since this is wasteful.

Furthermore, the type of feedback signals can be controlled by person-related parameters stored in a memory of an evaluation and control controller of an access control device or read from the data carrier of a user.

In the case of stored person-related parameters, it is possible to restrict the data input of an access request, either by active input or by reading an identification data carrier, merely to the data scope of the identification data whilst the further information responsible for the feedback signals need not be transmitted but are already stored in the memory of the evaluation and control controller of the access control device.

In the case of person-related parameters read from data carriers, no storage in the memory of the evaluation and control controller of the access control device is necessary. Rather, the person-related parameters can be used as control commands for the type and intensity of the feedback signals.

Orientation signals can be generated within the scope of the access request, which signals make it easier for a user to find a user communication terminal of an access control device for entering or for automatic reading of an identification code.

By this means, it is made substantially easier for both non-disabled people in the dark, and visually- and hearing-impaired people in everyday life, to specifically locate and operate the user communication terminal.

The orientation signals may only be switched on, adjusted or varied as soon as the approach of a person is detected by a proximity sensor.

By this means, energy is saved during the time in which no access request exists and any unnecessary adverse effect on persons located in the vicinity of the user communication terminal is avoided.

The type and intensity of the orientation signals can be controlled by ambient sensors which detect the ambient parameters.

By this means, adaptation to the ambient parameter is also achieved by analogy with the feedback signals.

It can furthermore be provided that the access control device is switched over from a standby mode to an operating mode as soon as the approach of a person is detected by a proximity sensor and after evaluating an access request or after a waiting time has lapsed, is switched back to the standby mode.

By this means, an even higher energy saving is achieved since during the usually substantially longer standby mode the access control device uses only a small standby current compared to the operating mode.

In a device for carrying out the method, the feedback device in each case comprises at least one signal generator from the plurality of audible, visual and tactile signal generators, wherein the signal generators can be selected by software or hardware logic of a terminal controller of a stationary user communication terminal or of an evaluation and door controller as a function of parameters from the plurality of person-related parameters which are stored or read from a data carrier, and ambient parameters and the signal intensity of at least one intensity-controllable signal generator can be controlled or adjusted by means of ambient parameters detected by means of ambient sensors.

It is hereby achieved that the signal generator of the feedback device can reach at least one perceptible sense of the person requesting access and can be automatically selected and adjusted without active intervention of the person requesting access.

The plurality of audible signal generators can comprise buzzer, beeper, loudspeaker, the plurality of visual signal generators can comprise lamp, light-emitting diode, running light, screen and the plurality of tactile signal generators can comprise Braille, Braille display, vibrator, infrasound generator, air flow generator, infrared flash.

The selection of at least one of these listed signal generators ensures that depending on the ambient influences or person-related impairments, it is always possible to communicate with the person requesting access in a suitable manner to transmit the evaluation result of an access request.

The plurality of ambient sensors can comprise microphone, photodetector, proximity sensor.

In this way, ambient parameters such as ambient noise, ambient brightness as well as the fact that a person is approaching can be detected and used to control the feedback device.

The input device of the stationary user terminal can comprise at least one input device or reader from the plurality of button, keyboard, touch-sensitive screen, microphone, reader for passive RFID data carriers, reader for active RFID data carriers or a communication device for a mobile user communication terminal. At the same time, the communication device can be assigned to the evaluation and control controller of the door controller or to the terminal controller of the user communication terminal.

It is thereby possible to adapt access requests individually to the capabilities of a person requesting access. Thus, in the case of non-disabled persons, button, keyboard, touch-sensitive screen and reader for passive RFID data carriers could be used since these persons can fulfil the requirements without any restriction.

In the case of disabled persons, a reader for an active RFID data carrier could be used if the person cannot operate or reach the input device of the stationary user communication terminal as a result of a disability. In this case, the transmission of the identification code takes place automatically as soon as the active RFID data carrier has entered into the reading range of the reader.

In addition, a mobile user communication terminal which is carried by a disabled person can be used and which comprises an input device with an input device or reader from the plurality of button, keyboard, microphone, reader for passive RFID data carriers and which can be connected by means of a non-contact communication path to the terminal controller of the stationary user communication terminal or the evaluation and control controller.

Such an input device or reader can make it substantially easier for a movement-impaired user to input an identification code or to handle a data carrier with identification code to be read.

The mobile user communication terminal can additionally comprise a feedback device with at least one signal generator from the plurality of audible, visual, tactile signal generator.

By this means, disabled users can obtain feedback signals directly at their location and away from the stationary user terminal.

Individual or a plurality of features of a disability from the plurality of mobility-impaired, visually impaired, colour blindness, hearing impaired can be stored as person-related parameters in the memory of an evaluation and control controller or can be read as a control feature of the terminal controller from the data carrier of a user.

In the case of storage, after identifying the person, it is possible to automatically evaluate features of a disability from the memory and select the most favourable type and intensity of feedback signal for the respective disability.

When reading features of a disability from a data carrier of a user, these features in the form of control commands can also selected feedback signals according to type and intensity. In this case, feedback signals are then selected according to type and intensity when a person requesting access carries a data carrier which is alien to the access control device or whose identification code is not stored in the memory of the evaluation and control controller of the door controller and therefore features of a disability linked to the identification code cannot be evaluated.

Furthermore, a language such as German, English, French, Russian, Japanese can be stored as a person-related parameter in the memory of the evaluation and control controller of the door controller or can be read as a control feature of the terminal controller from the data carrier of a user.

In the case of an institution with international employees, the communication language in which instructions in speech or text form can be issued and transmitted for the person requesting access can thus be selected automatically from the person-related parameters.

In addition, the user communication terminal can comprise an orientation signal generator for easier location of the input device.

The orientation signal generator can be formed by the feedback device and the signal generator of the feedback devices can be switched on, adjusted or varied by the terminal controller of the user communication terminal.

Since feedback signals and orientation signals need not be output simultaneously, a double usage of the signal generator provided and a selection according to type and intensity is possible.

The signal generators of the feedback device can be controlled by the terminal controller and the ambient sensors by reference to the ambient parameters.

It can thus be achieved that the orientation signals are only generated when a person requesting access approaches the user communication terminal. Furthermore, the type and intensity of the orientation signals can be adapted to the ambient parameters in similar manner to the feedback signals.

The invention is explained in detail hereinafter with reference to an exemplary embodiment which is shown in the drawings. In the figures:

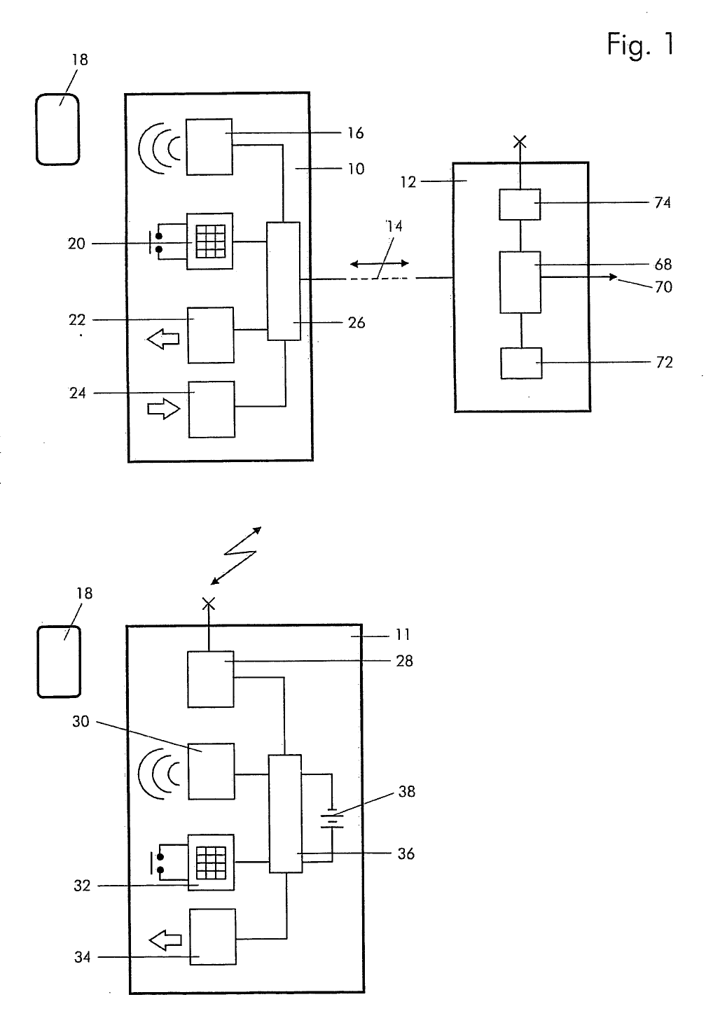

FIG. 1 shows a block diagram of an access control device according to the invention,

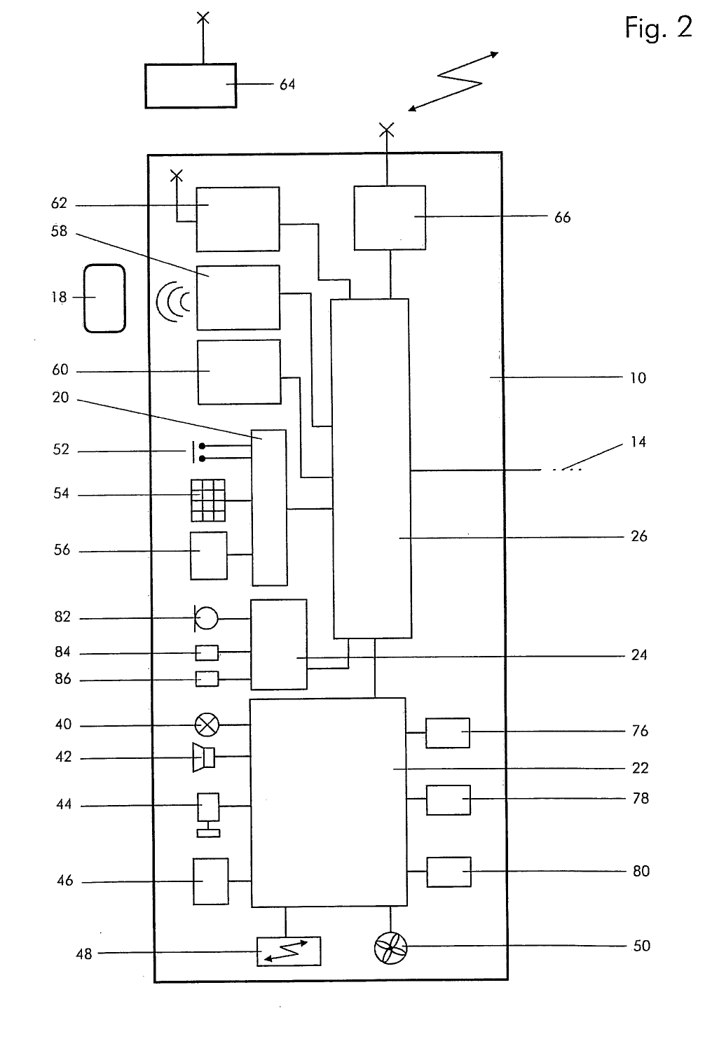

FIG. 2 shows a block diagram of a user communication terminal as a detail of the access control device.

The access control device shown in FIG. 1 comprises a stationary user communication terminal 10 which is connected to a door controller 12 via a bidirectional data line 14, and further a mobile user communication terminal 11. The user communication terminal 10 is located in a freely accessible area in front of an entrance door to a protected area whilst the door controller 12 is located in a protected area. The mobile user communication terminal 11 is intended to be carried by a movement-impaired person, e.g. in a wheelchair and allows this person to make an access request independently of the stationary user communication terminal. The door controller 12 comprises an evaluation and control controller 68 with a memory 72 and a communication device 74 for connection to the mobile user communication terminal 11. A door opener not shown here is connected to a control output 70 of the evaluation and control controller 68.

The task of the evaluation and control controller 68 is primarily to compare and evaluate by means of software or hardware logic, identification codes of persons requesting access obtained from the user communication terminal 10; 11 with reference data stored in the memory 72. The evaluation result is transmitted to the user communication terminal 10; 11 and there fed back to the user. If access is authorised, the door opener is additionally actuated by means of the control output 70.

Secondly, the evaluation and control controller 68 can control the type and intensity of feedback to a user from person-related parameters linked to reference data and stored in the memory 72, when corresponding identification codes are received.

The stationary user communication terminal 10 comprises a reader 16 for data carriers with identification codes, e.g. passive RFID data carriers 18, an input device 20, a feedback device 22, ambient sensors 24 and a terminal controller 26. The terminal controller 26 controls the internal data processing of the said components of the user communication terminal 10 and the bidirectional communication with the evaluation and control controller 68 of the door controller 12.

The user communication terminal 11 likewise comprises a reader 30 for data carriers with identification codes, e.g. passive RFID data carriers 18, an input device 32, a feedback device 34 and a terminal controller 36. A battery 38 serves as the power supply. The terminal controller 36 likewise controls the internal data processing of the said components of the user communication terminal 11 and the bidirectional communication with the evaluation and control controller 68 of the door controller 12 but by means of a communication device 28 via a non-contact communication path with the communication device 74 of the door controller 12.

FIG. 2 shows an expanded block diagram of the user communication terminal 10 with further details.

The feedback device 22 comprises signal generators from the plurality of audible, visual, tactile signal generators and specifically an output via a screen 46, a Braille display 76, an output via beeper or loud speaker 42, an output via light-emitting diodes 40, an output via running light 78, an output via vibrator 44, an output via infrasound generator 80, an output via infrared flash 48 and an output via air flow generator 50.

The input device comprises a reader 58 for passive RFID data carriers 18, a reader 62 for active RFID data carriers 64, a reader 60 for magnetic or contact data carriers, an input device 20 with a keypad 54, a button 52 and a touch-sensitive screen 56. Furthermore, a communication device 66 is provided, via which a mobile user communication terminal 11 can communicate in a non-contact manner with its communication device 28 (see FIG. 1) if the communication device 74 of the door controller 12 is in an RF-shielded area or too far removed.

Ambient sensors 24 of the stationary user communication terminal 10 comprise a microphone 82 as a sensor for ambient noise, a photosensor 84 as a sensor for ambient brightness and a proximity sensor 86. The terminal controller 26 has software or hardware logic by which means the type and possibly also the intensity of the feedback signals are controlled from the ambient parameters obtained from the ambient sensors. For this, individual or a combination of several signal generators of the feedback device 22 are selected and activated adapted to the respective case of requirement.

Additionally or exclusively, data read from the data carriers 18; 64, which are transmitted additionally to identification codes, are evaluated for person-related parameters by means of the software or hardware logic of the terminal controller 26. In the presence of such person-related parameters such as type and degree of disabilities and/or preferred languages, the type and optionally also the intensity of the feedback signals are likewise controlled. This is also accomplished by individual or a combination of several signal generators of the feedback device 22 being selected and activated. At the same time, a selection of the signal generator can also be made with additional logical linking of the ambient parameters obtained from the ambient sensors.

In the time between submitted access requests, the signal generators of the feedback device 22 are switched on and used as orientation signal generators in order to make it easier for a person requesting access to located the user communication terminal 10. For this the terminal controller 26 selects the type and intensity of the orientation signals by selecting and activating one or a combination of the signal generators of the feedback device 22.

For selecting the type and intensity of the signal generator of the feedback device 22, ambient parameters from the ambient sensors 24 are also evaluated in this case by analogy with the feedback signals. By evaluating signals of the proximity sensor 86, the orientation signals are only generated when the approach of a person requesting access is detected.

The mode of operation is described hereinafter with reference to some scenarios.

a) In the case of low ambient brightness and low ambient noise and when evaluating the person-related parameters to the effect that a non-disabled person is requesting access, it is initially checked whether access can be granted or not after evaluating the input or read identification codes by comparison with stored reference data. If access is granted, the lock of a door is then released in the usual manner or the door is opened automatically. On the other hand, if the access request is not permissible, this is omitted.

The evaluation result is transmitted to the person requesting access via the feedback device 22, in which case only the output by a buzzer 42 and by a light-emitting diode 40 is signalled in the intensity of a pre- or base setting.

b) In the case of elevated ambient noise or elevated ambient brightness, this state is detected by corresponding sensors 24 and the sound intensity of the buzzer 42 or the brightness intensity of the light-emitting diode 40 is increased according to the type of ambient parameters. If the ambient sensors 24 determine an ambient brightness and an ambient noise at which neither an audible nor a visual feedback signal, even at maximum intensity, can exceed the ambient interference to such an extent that they can still be perceived, a tactile signal generator, e.g. the vibrator 44 is selected and activated. This sets the housing of the user communication terminal 10 in vibration and can thus transmit a feedback signal to the user when he touches the housing with his hand.

c) If the evaluation of person-related parameters reveals a disability of the person requesting access, a different signal generator is selected additionally or alternatively, which ensures reliable transmission of the feedback signal according to the type of disability. If the disabled person is visually impaired, visual signal generators are switched off, audible signal generators are switched on or remain switched on and optionally tactile signal generators can be activated. These can comprise a Braille display 76, a vibrator 44 on the housing of the user communication terminal 10, an infrasound generator 80, an infrared flash 48, an air flow generator 50 or a combination of individual ones of these signal generators.

d) If the person requesting access is merely colour-blind, instead of the light-emitting diode output, a running light 78 can be activated, from the direction of which the type of feedback signal (access allowed, access granted, access data incorrect or cannot be evaluated) can be read off.

e) If a person requesting access is deaf, audible signal generators are switched off and only individual or several of the signal generators which allow visual or tactile recognition are activated.

In the case of persons requesting access who are both visually and hearing impaired, audible and visual signal generators are switched off and only one or more of the tactile signal generators are activated.

f) In the case of persons requesting access having restricted mobility, who cannot operate buttons, keypads or feed or bring a data carrier close to the reader of the user communication terminal, it can be provided that these persons can express their access request with an active RFID data carrier 64 over a fairly large distance from the reader 62. In this case, the software or hardware logic of the terminal controller 26 can select whether voice communication is made between a base or feedback signals are generated via infrasound generator 80, infrared flash 48 or air flow generator 50.

Additionally or alternatively, however, these persons can also carry a mobile user communication terminal 11. This uses a non-contact communication path to the stationary user communication terminal 10. For example, a reader 62 for an active RFID data carrier 64 can be switched on via a button on the input device 32 and the active RFID data carrier 64 can be made to transmit. Identification codes can be transmitted similarly at a distance in a non-contact manner for input or for reading by means of the stationary user communication terminal via a keypad of the input device 32 and/or a reader 30 for passive RFID data carriers 18.

g) If feedback is output in detailed form in plain text via a screen 46 or a loudspeaker 42, the language in which optimal communication can be made with the person requesting access can additionally be selected by means of stored person-related parameters and the logic of the terminal controller 26 of the user communication terminal 10.

h) On approach of a person requesting access, orientation signals which make it easier to locate the user communication terminal 10 are generated via an orientation signal generator which can also be formed by the feedback device 34. When access is granted, a signal which makes it easier to locate the access door can also be generated.

i) In the event of changes in the ambient parameters, these are detected by the ambient sensors 24 and adapted to the orientation signals so that these can also be perceived at elevated ambient brightness and noise.

### REFERENCE LIST

10 Stationary user communication terminal

11 Mobile user communication terminal

12 Door controller

14 Data line

16 Reader

18 Passive RFID data carrier

20 Input device

22 Feedback device

24 Ambient sensors

26 Terminal controller

28 Communication device

30 Reader

32 Input device

34 Feedback device

36 Terminal controller

38 Battery

40 LED

42 Beeper or loudspeaker

44 Vibrator

46 Screen

48 Infrared flash

50 Air flow generator

52 Button

54 Keypad

56 Touch-sensitive screen

58 Reader for passive RFID data carrier

60 Reader for contact or magnetic strip data carrier

62 Reader for active RFID data carrier

64 Active RFID data carrier

66 Communication device

68 Evaluation and control controller

70 Door opener output

72 Memory

74 Communication device

76 Braille display

78 Running light

80 Infrasound generator

82 Microphone

84 Photosensor

86 Proximity sensor

1. A method for generating an information signal in the event of an access request to a user by triggering at least one feedback signal after entering or automatic reading of an identification code and comparing the identification code with stored reference data, wherein the type and intensity of the at least one feedback signal is controlled as a function of parameters from the plurality of ambient parameters and person-related parameters.

2. The method according to claim 1, wherein the at least one feedback signal is selected from the plurality of visual feedback signal, audible feedback signal, tactile feedback signal as a function of parameters from the plurality of ambient parameters and person-related parameters and intensity-controllable parameters are adjusted with respect to perturbing ambient parameters with a signal-to-noise ratio with respect to the ambient parameters, which allows reliable perception.

3. The method according to claim 1, wherein the type of feedback signals and the intensity of the intensity-controllable feedback signals are fixedly adjusted.

4. The method according to claim 1, wherein the type of feedback signals and the intensity of the intensity-controllable feedback signals are automatically adjusted and adapted to the ambient parameters.

5. The method according to claim 4, wherein the intensity-controllable feedback signals are pre-adjusted to a base value and the intensity is only raised when the signal-to-noise ratio resulting from the ambient parameters falls below a predetermined limiting value.

6. The method according to claim 1, wherein the intensity of the feedback signals is controlled by sensors which detect the ambient parameters.

7. The method according to claim 1, wherein the type of feedback signal is controlled by sensors which detect the ambient parameters.

8. The method according to claim 1, wherein the type of feedback signal is controlled by person-related parameters stored in a memory of an evaluation and control controller of an access control device or read from the data carrier of a user.

9. The method according to claim 1, wherein orientation signals are generated within the scope of the access request, which signals make it easier for a user to find a user communication terminal of an access control device for entering or for automatic reading of an identification code.

10. The method according to claim 10, wherein the orientation signals are switched on, adjusted or varied as soon as the approach of a person is detected by a proximity sensor.

11. The method according to claim 9, wherein the type of orientation signal is controlled by sensors which detect the ambient parameters.

12. The method according to claim 1, wherein the access control device is switched over from a standby mode to an operating mode as soon as the approach of a person is detected by a proximity sensor and after evaluating an access request or after a waiting time has lapsed, is switched back to the standby mode.

13. A device for carrying out the method according to claim 1 comprising an access control device consisting of a stationary user communication terminal with an input device and a feedback device as well as consisting of an evaluation and control controller with a memory, wherein the feedback device in each case comprises at least one signal generator from the plurality of audible, visual and tactile signal generators, that the signal generators can be selected by software or hardware logic of a terminal controller of the stationary user communication terminal or of the evaluation and control controller as a function of parameters from the plurality of person-related parameters which are stored or read from a data carrier, and ambient parameters and that the signal intensity of at least one intensity-controllable signal generator can be controlled or adjusted by means of ambient parameters detected by means of ambient sensors.

14. The device according to claim 13, wherein the plurality of audible signal generators comprises buzzer, beeper, loudspeaker, that the plurality of visual signal generators comprises lamp, light-emitting diodes, running light, screen and that the plurality of tactile signal generators comprises Braille, Braille display, vibrator, infrasound generator, infrared flash.

15. The device according to claim 13, wherein the plurality of ambient sensors comprises microphone, photodetector, proximity sensor.

16. The device according to claim 13, wherein the input device of the stationary user terminal comprises at least one input device or reader from the plurality of button, keyboard, touch-sensitive screen, microphone, reader for passive RFID data carriers, reader for active RFID data carriers or a communication device for a mobile user communication terminal.

17. The device according to claim 16, wherein the mobile user communication terminal comprises an input device with an input device or reader from the plurality of button, keyboard, microphone, reader for passive RFID data carriers and can be connected by means of a non-contact communication path to the terminal controller of the stationary user communication terminal or the evaluation and control controller of the door controller.

18. The device according to claim 16, wherein the mobile user communication terminal additionally comprises a feedback device with at least one signal generator from the plurality of audible, visual, tactile signal generator.

19. The device according to claim 13, wherein individual or a plurality of features of a disability from the plurality of mobility-impaired, visually impaired, colour color blindness, hearing impaired are stored as person-related parameters in the memory of an evaluation and control controller or can be read as a control feature of the terminal controller from the data carrier of a user.

20. The device according to claim 13, wherein a language such as German, English, French, Russian, Japanese is stored as a person-related parameter in the memory of the evaluation and control controller or can be read as a control feature of the terminal controller from the data carrier of a user.

21. The device according to claim 12, wherein the user communication terminal comprises an orientation signal generator for easier location of the input device.

22. The device according to claim 21, wherein the orientation signal generator is formed by the feedback device and the signal generator of the feedback devices can be switched on, adjusted or varied by the terminal controller of the user communication terminal.

23. The device according to claim 21, wherein the signal generator of the feedback device can be controlled by the terminal controller and the ambient sensors by reference to the ambient parameters.
